(19) United States
(12) Patent Application Publication
(10) Pub. No.: US 2010/0017637 A1
(43) Pub. Date: Jan. 21, 2010

(54) PORTABLE ELECTRONIC TERMINAL AND METHOD THEREFOR

(75) Inventor: Arnaud Rosay, Voivres Les Le Mans (FR)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 11/915,488

(22) PCT Filed: May 15, 2006
(86) PCT No.: PCT/IB06/51510

§ 371 Date: Oct. 6, 2009

(30) Foreign Application Priority Data
May 25, 2005 (EP) 05300412.3

(51) Int. Cl. G06F 1/32

(52) U.S. Cl. 713/323

(57) ABSTRACT

A portable electronic terminal capable of changing to an idle or sleep mode during which selective powering of portions of the electronics of the terminal takes place to save energy, the terminal comprising:—at least one memory storing, when in the idle or sleep mode, a program code of a background task and data necessary for the execution of the background task,—a calculator (6) adapted to execute the program code directly from said at least one memory when the terminal is in the idle or sleep mode, wherein said at least one memory includes a NVRAM (Non-Volatile Random Access Memory) (12) which consumes no power to retain and access stored information, the NVRAM storing the program code and/or the data.

### FIELD OF THE INVENTION

The present invention relates to portable electronic terminals and methods therefor.

### BACKGROUND OF THE INVENTION

Typically, portable electronic terminals automatically shift to idle or sleep mode when not used. When in the idle or sleep mode, terminals selectively power portions of their electronics to save energy.

In some portable electronic terminals, like cellular mobile phones, the idle mode differs from the sleep mode by the number of system clocks switched off. In other terminals, these two modes are identical.

An example of a portable electronic terminal capable of shifting to idle or sleep mode can be found in U.S. Pat. No. 6,151,262.

Known portable electronic terminals comprise:

at least one memory, when in the idle or sleep mode, storing a program code of a background task and data necessary for the execution of the background task,

a calculator adapted to execute the program code directly from said at least one memory when the terminal is in the idle or sleep mode.

By directly executing a program code from a memory we mean that it is not necessary for copy the program code in another memory before starting to execute the program code. The instructions that form the program code can be read directly by the calculator or processor that executes them via a data bus.

As an example, the at least one memory includes a FLASH memory storing the program code and a VRAM (Volatile Random Access Memory) storing the data. The VRAM is permanently powered to retain the data when in the idle or sleep mode. The FLASH memory is also permanently powered to allow fast reading of the program code. Therefore, the execution of the background task can be resumed in a very short time because data necessary for its execution are already in the VRAM and FLASH memory is already ready to be read. However, powering a VRAM and a FLASH memory even during the idle or sleep mode consumes energy.

### SUMMARY OF THE INVENTION

Accordingly, it is an object of the invention to provide a portable electronic terminal that consumes less energy when in the idle or sleep mode.

With the foregoing and other objects in view there is provided, in accordance with the invention, a portable electronic terminal wherein the at least one memory includes a NVRAM (Non-Volatile Random Access Memory) which consumes no power to retain and access stored information, the NVRAM storing the program code and/or the data.

It is possible to read information in a NVRAM as fast as in a RAM like DRAM (Dynamic Random Access Memory) or SRAM (Static Random Access Memory) because NVRAM operates like a RAM. Thus, the time necessary for resume and execute the background task is as good as in known terminals. However, contrary to conventional RAM, NVRAM is a non-volatile memory and requires no power to retain or access stored information. As a result, the power consumption of the above terminal in the idle or sleep mode is reduced.

The embodiments of the above terminal may comprise one or several of the following features:

the NVRAM stores both the program code of the background task and the data necessary for the execution of the background task,

the terminal comprises at least one volatile RAM (Random Access Memory) that stores data necessary for the execution of foreground tasks that are not executed when in the idle or sleep mode,

the terminal is adapted to power off said at least one volatile RAM when in the idle or sleep mode,

the terminal comprises an erasable programmable non-volatile ROM (Read Only Memory) storing the program codes of the foreground tasks,

the NVRAM is a MRAM (Magnetoresistive Random Access Memory) or a FRAM (Ferroelectric Random Access Memory),

the terminal is a portable cellular phone.

The above embodiments of the terminal present the following advantages:

storing both the program code and the data in the NVRAM further reduces the energy consumption,

storing data that are not useful for the execution of the background task in a volatile memory reduces the amount of data stored in the NVRAM and so reduces the overall cost of the terminal because volatile memories are cheaper than NVRAM,

powering off the volatile memory when in the idle or sleep mode, saves energy,

using erasable programmable non-volatile ROM allows program codes to be upgraded.

The invention also relates to a method of managing a portable electronic terminal when in an idle or sleep mode during which selective powering of portions of the electronics of the terminal takes place to save energy, the method comprising, when in the idle or sleep mode, the steps of:

storing a program code of a background task and data necessary for the execution of the background task in at least one memory,

directly executing the program code from said at least one memory, wherein said at least one memory includes a NVRAM (Non-volatile Random Access Memory) which consumes no power to retain and to access stored information, the NVRAM storing the program code and/or the data.

The embodiments of the above method may comprise one or several of the following features:

the method comprises the step of storing data necessary for the execution of foreground tasks that are not executed when in the idle or sleep mode, in at least one volatile RAM (Random Access Memory),

the method comprises the step of storing the program code of the foreground tasks in an erasable programmable non-volatile ROM (Read-Only Memory).

This and other aspects of the invention will be apparent from the following description, drawings and claims.

### BRIEF DESCRIPTION OF THE DRAWINGS

FIG. 1 is a schematic diagram of a portable electronic terminal;

FIG. 2 is a flowchart of a method to manage the portable electronic terminal of FIG. 1 when in the idle or sleep mode.

### DESCRIPTION OF THE PREFERRED EMBODIMENTS

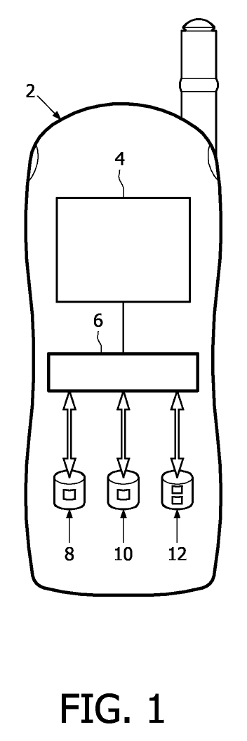

FIG. 1 shows a portable electronic terminal 2. Terminal 2 is a cellular mobile phone designed to communicate with a base station of a cellular telephone network.

FIG. 1 shows only the details necessary for understand the invention.

Terminal 2 has a display 4 to present information to a user of terminal 2. Display 4 can be switched on and switched off.

Terminal 2 also includes a calculator 6, which is capable of executing program codes to execute background and foreground tasks. Foreground tasks are only executed when terminal 2 is fully powered, whereas background tasks are also executed when terminal 2 is in the idle or sleep mode. When in the idle or sleep mode, only selective portions of the electronics of terminal 2 are powered to save energy. For example, when in the idle or sleep mode, screen 4 is switched off.

The program code corresponding to foreground tasks are stored in an erasable programmable NVROM (Non-Volatile Read-Only Memory) 8. For example, NVROM 8 is a FLASH memory.

Examples of foreground task functions are the following:

telephone call emission,

telephone directory management,

taking pictures if terminal 2 is equipped with a camera.

Data necessary for execute foreground tasks are stored in a volatile RAM 10 (Random Access Memory). As an example, RAM 10 is a DRAM (Dynamic Random Access Memory) or a SRAM (Static Random Access Memory).

The program code of the background task and the data necessary for the execution of the background task are stored in a NVRAM (Non-Volatile Random Access Memory) 12 that consumes no power to retain and to access stored information. NVRAM 12 operates like a conventional RAM except that it is a non-volatile memory.

For example the background task is a synchronization task of terminal 2 with a base station to be able to receive incoming calls. The synchronization task consists of listening to information from a base station to obtain network information. For instance, the data stored in NVRAM 12 are time instants to listen to the base station and emitting power necessary for communicate with the base station.

For example NVRAM 12 is a MRAM (Magnetoresistive Random Access Memory) or a FRAM (Ferroelectric Random Access Memory).

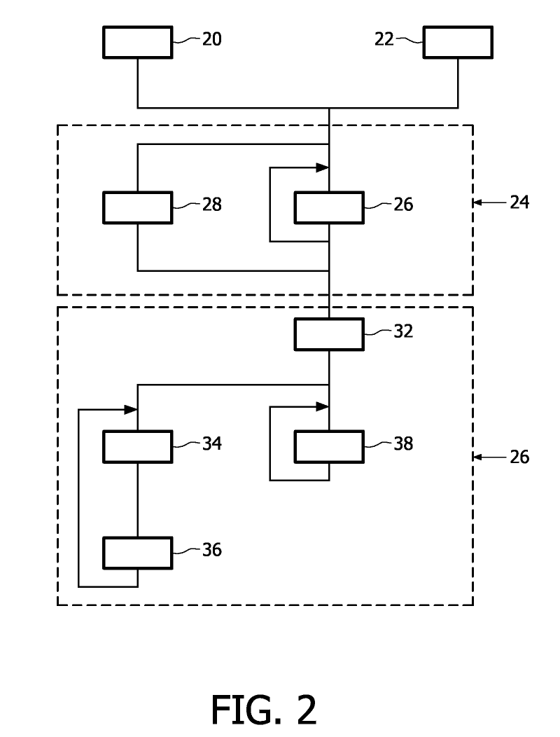

The operation of terminal 2 will now be described with reference to FIG. 2.

At an initial stage, for example during manufacturing of terminal 2, in step 20, the program code of the background task and data necessary for the execution of the background task are recorded in NVRAM 12.

During this initial stage, in step 22, the program codes of the foreground tasks are stored in NVROM 8.

Terminal 2 automatically shifts to an idle or sleep mode 24 when it is powered and not used.

During idle or sleep mode 24, in step 26, calculator 6 directly executes the program code of the background task from NVRAM 12 and, if necessary, records updated data in NVRAM 12. Step 26 is regularly repeated throughout the idle or sleep mode. In parallel to step 26, in step 28 at the beginning of idle or sleep mode 24, the power of VRAM 10 and NVROM 8 is switched off. As a result, data recorded in VRAM 10 are lost and memory accesses to NVROM 8 are no more possible. NVROM 8 and VRAM 10 remain unpowered as long as terminal 2 is in the idle or sleep mode.

During idle or sleep mode, display 4 is also switched off.

In response to a manual operation of the user of terminal 2 or to receive an incoming call, terminal 2 automatically shifts from the idle or sleep mode to an active mode 26, for example.

At the beginning of active mode 26, in step 32, all the electronics of terminal 2 is powered on. For example, the power of display 4, NVROM 8, VRAM 10 is switched on.

Then, in step 34, data necessary for the execution of foreground tasks are restored in VRAM 10.

Subsequently, in step 36, foreground tasks are directly executed from NVROM 8 using data restored in VRAM 10.

Steps 34 and 36 can be repeated for different foreground tasks.

In parallel to steps 34 and 36, in step 38, the background task continues to be directly executed by calculator 6 from NVRAM 12.

Many additional embodiments are possible. For example, the program code of the background task is stored in NVROM 8 instead of NVRAM 12 and data necessary for the execution of the background task remain stored in NVRAM 12. Because the programs code of background task is stored in NVROM 8, NVROM 8 is powered even during the idle or sleep mode. In this embodiment, only VRAM 10 is powered off when in the idle or sleep mode.

Similarly, in another embodiment, the data necessary for the execution of the background tasks are stored in VRAM 10 and the program code of the background task is stored in NVRAM 12. In this embodiment, VRAM 10 is permanently powered during the idle or sleep mode. However, when in the idle or sleep mode, NVROM 8 need not be powered.

In the two previous alternative embodiments, the amount of information to be stored in NVRAM 12 is reduced. This reduces the manufacturing cost because NVRAM 12 is more expensive than NVROM or VRAM. However, the amount of energy saved during the idle or sleep mode is lower than the one saved in the main embodiment.

1. A portable electronic terminal capable of shifting to an idle or sleep mode during which selective powering of portions of the electronics of the terminal takes place to save energy, the terminal comprising:
at least one memory storing, when in the idle or sleep mode, a program code of a background task and data necessary for the execution of the background task;
a calculator adapted to execute the program code directly from said at least one memory when the terminal is in the idle or sleep mode;
wherein said at least one memory includes a NVRAM (Non-Volatile Random Access Memory) which consumes no power to retain and to access stored information, the NVRAM storing the program code and/or the data.

2. The portable electronic terminal according to claim 1, wherein the NVRAM stores both the program code of the background task and the data necessary for the execution of the background task.

3. The portable electronic terminal according to claim 1, wherein the terminal comprises at least one volatile RAM (Random Access Memory) that stores data necessary for the execution of foreground tasks that are not executed when in the idle or sleep mode.

4. The portable electronic terminal according to claim 3, wherein the terminal is adapted to power off said at least one volatile RAM when in the idle or sleep mode.

5. The portable electronic terminal according to claim 3, wherein the terminal comprises an erasable programmable non-volatile ROM (Read Only Memory) storing the program codes of the foreground tasks.

6. The portable electronic terminal according to claim 1, wherein the NVRAM is a MRAM (Magnetoresistive Random Access Memory) or a FRAM (Ferroelectric Random Access Memory).

7. The portable electronic terminal according to claim 1, wherein the terminal is a portable cellular phone.

8. A method of managing a portable electronic terminal when in an idle or sleep mode during which selective powering of portions of the electronics of the terminal takes place to save energy, the method comprising, when in the idle or sleep mode, the steps of:
storing a program code of a background task and data necessary for the execution of the background task in at least one memory;
directly executing the program code from said at least one memory;
wherein said at least one memory includes a NVRAM which consumes no power to retain and to access stored information, the NVRAM storing the program code and/or the data.

9. The method according to claim 8, wherein the method comprises the step of storing data necessary for the execution of foreground tasks that are not executed when in the idle or sleep mode, in at least one volatile RAM.

10. The method according to claim 9, wherein the method comprises the step of storing the program code of the foreground tasks in an erasable programmable non-volatile ROM.
